(19) United States
(12) Patent Application Publication
(10) Pub. No.: US 2009/0007586 A1
(43) Pub. Date: Jan. 8, 2009

(54) Apparatus for cooling food under water and maintaining water temperature therefor

(75) Inventor: Shintaro Takenaka, Fukuyama-shi (JP)

Correspondence Address: MERCHANT & GOULD PC, P.O. BOX 2903, MINNEAPOLIS, MN, 55402-0903, US

(73) Assignee: SHINYO Industries, Co., Ltd., Fukuyama-shi (JP)

(21) Appl. No.: 12/217,196

(22) Filed: Jul. 1, 2008

(30) Foreign Application Priority Data
Jul. 2, 2007 (JP) 2007-200033

(51) Int. Cl. F25D 25/04; F25D 23/00; B01F 11/02

(52) U.S. Cl. 62/374; 62/336; 366/116; 62/264

(57) ABSTRACT

An underwater-cooling water-temperature maintaining apparatus of a food includes: a water tank where a cooled stuff and cooling treated water of which a freezing point is not more than zero Celsius degree; a treated water cooler configured to cool the cooling treated water; a water temperature detection sensor configured to detect a water temperature of the cooling treated water; an agitator pump configured to equalize the water temperature of the cooling treated water in the water tank; ultrasonic vibrators configured to oscillate ultrasound toward an inside of the water tank in order to prevent the cooled stuff from being frozen; and a controller configured to control the ultrasonic vibrators, the water temperature detection sensor, the treated water cooler, and the agitator pump so as to maintain the water temperature of the cooling treated water at a temperature at which the cooled stuff is not frozen.

### BACKGROUND OF THE INVENTION

1. Field of the Invention

The present invention relates to an apparatus for cooling a food containing moisture, particularly, a fresh food, under water and maintaining a water temperature therefor (hereinafter appropriately referred to as “underwater-cooling water-temperature maintaining apparatus of a food”), and for storing the fresh food without freezing it.

2. Description of the Related Art

While a circulation of a fresh food increases at home and abroad, a method for keeping freshness of the food is a method of refrigerating the food at a low temperature, maintaining its freshness, and storing it (hereinafter appropriately referred to as “low-temperature-refrigeration freshness-maintaining and storing method”), which the method does not change from a birth of a refrigerator until now. A refrigerator and a cooler and warmer utilize this low-temperature-refrigeration freshness-maintaining and storing method, store a fresh food, and maintain its freshness. The low-temperature-refrigeration freshness-maintaining and storing method includes the steps of: an air cooler comprised by the refrigerator blowing cool wind therein; reducing an air temperature therein to a low temperature; thereby reducing a temperature of a fresh food itself to around zero Celsius degree; and maintaining the freshness of the food.

Furthermore, in order to prevent a food from drying, generally at home is used a wrap film for packing the food, which the film is made of synthetic resin such as polychloride vinylidene and polyethylene, and the food is packed and stored in a refrigerator and the like. However, no matter how a wrap film for packing a food is thick, it is impossible to prevent moisture in the food from being evaporated, and therefore, it is not possible to maintain its freshness.

A food described in the specification means foods other than a dried food. For example, fishes, meats, cereals before and after cooking, fruits, vegetables, Japanese cakes, raw cakes, and the like.

According to the low-temperature-refrigeration freshness-maintaining and storing method, because an air relative humidity in a refrigerator is extremely reduced, the air in the refrigerator becomes dry. Therefore, a fresh food becomes dry over time in its surface, and its inside moisture is also reduced. Thus freshness of the fresh food is degraded.

Furthermore, according to a method of reducing a temperature of a fresh food by cool air, it takes a long time until the temperature of the food itself is reduced to around zero Celsius degree. Moreover, because an outside portion of the fresh food is cooled faster in temperature than a core portion thereof, and a temperature difference is generated between the outside portion and the core portion; thus when the cooling of the core portion is completed, the outside portion is frozen in some cases, and a texture of the fresh food is changed.

Consequently, there is a need for an apparatus (hereinafter referred to as “underwater-cooling water-temperature maintaining apparatus”) that maintains a water temperature in underwater cooling of a food, particularly, a fresh food which contains moisture, and storing the food without freezing it.

### SUMMARY OF THE INVENTION

The present invention relates to an underwater-cooling water-temperature maintaining apparatus comprising: ultrasonic vibrators configured to oscillate ultrasound toward an inside of a water tank, where a cooled stuff is put in the water tank filled with treated water of ethanol blended water, in order to prevent the cooled stuff from being frozen; a treated water cooler configured to maintain a temperature of the treated water at which the cooled stuff is not frozen; a treated water temperature detection sensor; an agitator pump; and a controller configured to control these.

According to the present invention, it is possible to provide the underwater-cooling water-temperature maintaining apparatus that maintains the freshness and quality of a food without freezing a cooled stuff, compared to an apparatus using a conventional underwater-cooling water-temperature-maintaining and storing method.

### BRIEF DESCRIPTION OF THE DRAWINGS

FIG. 1 is a whole section view of an underwater-cooling water-temperature maintaining apparatus.

FIG. 2 is a whole section view of an underwater-cooling water-temperature maintaining apparatus where an underwater-rotation mesh basket is installed.

FIG. 3 is a whole section view of an underwater-cooling water-temperature maintaining apparatus where upper and lower conveyors are installed.

FIG. 4 is a whole section view of an underwater-cooling water-temperature maintaining apparatus in which ice blocks are put.

FIG. 5 is a whole section view of an underwater-cooling water-temperature maintaining apparatus where a box and other boxes are thrown in a water tank, wherein underwater ultrasound vibrators to which fallopian-tube wave diffusion guides are respectively attached are put in the former box, and underwater ultrasound vibrators without fallopian-tube wave diffusion guides are put in the latter boxes.

### BEST MODE FOR CARRYING OUT THE INVENTION

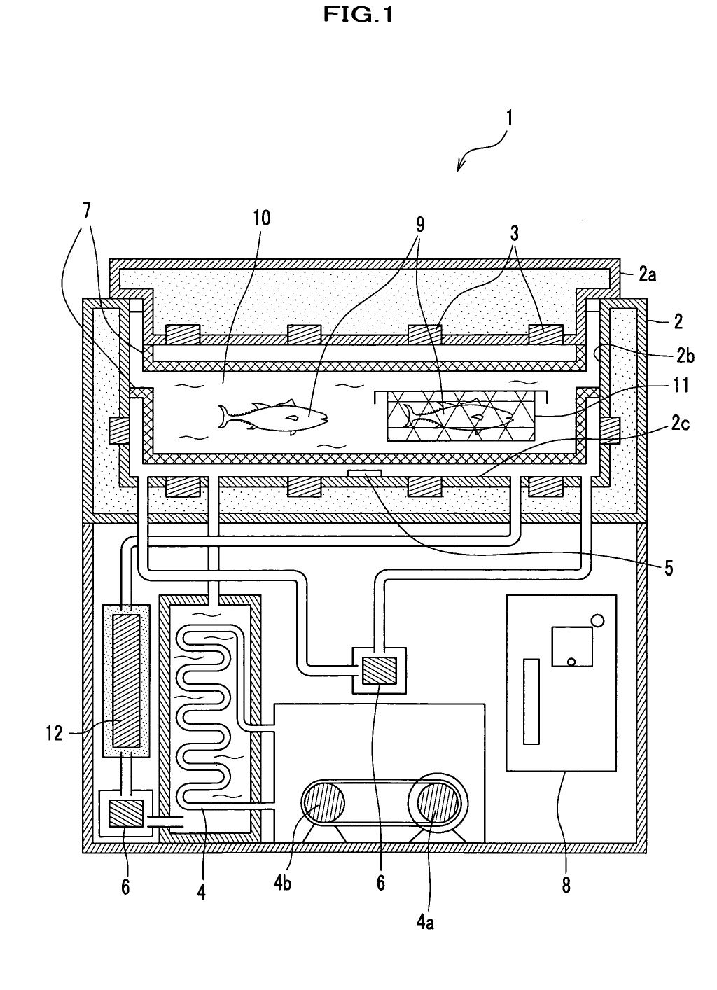

As shown in FIG. 1, an underwater-cooling water-temperature maintaining apparatus 1 comprises a water tank 2 including a water tank lid 2a, tank side walls 2b, and a tank bottom 2c; ultrasonic vibrators 3: a treated water cooler 4; a thermistor temperature sensor 5; an agitator pump 6; underwater wave diffusion nets 7; and an electric control panel 8.

In the water tank 2 is filled ethanol blended water 10 containing clear water and ethanol. A condition of the ethanol blended water 10 is that it is not frozen at around zero Celsius degree because a purpose of the water 10 is to store foods 9 under water at zero Celsius degree. Therefore, an addition amount of ethanol is enough if it is five percent of clear water.

The water tank 2 is made a double-layer structure in the walls 2b and bottom 2c of the tank 2 and the water tank lid 2a in order to maintain a temperature of the ethanol blended water 10 in the tank 2; a space between the double layers is made a vacuum and the tank 2 is made a heat-insulation-structure treatment tank of a vacuum heat insulation.

However, if the heat-insulation-structure treatment tank is not used, a heat insulation material may also be attached to the outside of the water tank 2, and a cosmetic sheet and the like may also be attached thereto as a product.

The ultrasonic vibrators 3 are attached to the walls 2b and bottom 2c of the water tank 2 and the water tank lid 2a. However, depending on a kind, shape, and number and amount of the foods 9 to be cooled, the ultrasonic vibrators 3 may be attached to any of the walls 2b and bottom 2c of the water tank 2 and the water tank lid 2a.

A frequency of ultrasound oscillated by the ultrasonic vibrators 3 is selected so that a heat conversion of an underwater wave energy is performed to an extent that the heat conversion does not affect a texture of the foods 9 and to an extent that the foods 9 receiving the energy as its output for five minutes increase in temperature by one Celsius degree. In the water tank 2 made of stainless steel which is 100 liters in water volume and 350 mm in water depth, the ultrasonic vibrators 3 of a frequency of 120 kHz and an output of 1 kW are used.

Furthermore, even if the frequency of ultrasound oscillated by the ultrasonic vibrators 3 is around 2000 kHz in maximum, it is confirmed that the texture of the foods 9 is not affected due to the heat conversion of the underwater wave energy. Therefore, frequencies of around 25 kHz, 40 kHz, 80 kHz, 120 kHz, 170 kHz, 500 kHz, 1000 kHz, 1500 kHz, and 2000 kHz may also be used.

The treated water cooler 4 is sufficient if it has an enough cooling capacity capable of: receiving an underwater wave energy generated through ultrasound oscillated by the ultrasonic vibrators 3; increasing the temperature of the foods 9 by one Celsius degree per five minutes due to the heat conversion; cooling the foods 9 put in the ethanol blended water 10 of the water tank 2; and further adjusting the temperature of the water 10 in order to further maintain the temperature to be zero Celsius degree.

As a treated water temperature detection sensor, the thermistor temperature sensor 5 is used for measuring the temperature of the treated water at an error of ±1 Celsius degree.

Although a thermistor control may control the temperature of the treated water (ethanol blended water 10) at an error of ±0.25 Celsius degree by using a control relay function, if controlling the temperature in a range of a small error, it always controls the temperature, and a defect (continuous contact and non-contact phenomenon) may occur at a contact point of the relay; therefore, for safety, it is assumed that the thermistor control controls the temperature at the error of ±1 Celsius degree.

The underwater wave diffusion nets 7 are attached with a distance of about 20 mm from the ultrasonic vibrators 3 attached to the water tank 2. The underwater wave diffusion nets 7 are nets for diffusing in the water tank 2 waves having a straight proceeding property of ultrasound and one point concentration property of the underwater wave energy of the ultrasound oscillated by the ultrasonic vibrators 3.

The foods 9 may be put directly on a lower underwater wave diffusion net 7, or an underwater-rotation mesh basket 11 may be used, the food 9 may be put therein, and the basket 11 may be put on the underwater wave diffusion net 7.

The agitator pump 6 circulates the ethanol blended water 10 in the water tank 2 and equalizes the temperature of the water 10.

All appliances of the present invention are controlled by the electric control panel 8.

Thus described, in accordance with the underwater-cooling water-temperature maintaining apparatus 1 of the foods 9 of an embodiment of the present invention, the foods 9 are cooled by utilizing a thermal conductance due to the temperature of the ethanol blended water 10 being zero Celsius degree, and simultaneously, a thermal conductance to the outside portion and core portion of the foods 9 may be equally and rapidly propagated by utilizing waves generated by ultrasound oscillated by the ultrasonic vibrators 3. Therefore, although the cooling processing is performed by the hour according to the conventional low-temperature-refrigeration freshness-maintaining and storing method, it has become possible to perform cooling processing by the minute according to the underwater-cooling water-temperature maintaining apparatus 1.

Thus according to the conventional low-temperature-refrigeration freshness-maintaining and storing method, a quality degradation is generated due to cooling over a long time; whereas, according to the present invention, the quality degradation due to dryness is not generated because the foods 9 are cooled under water. Therefore, the quality degradation of the foods 9 due to the moisture movement of the core portion of the foods 9 is completely avoided.

In order to maintain a limit temperature just before a freeze, it is requested to perform a high accuracy temperature control, and according to the invention, the thermistor control is used, the temperature of the treated water is set to be zero Celsius degree and is maintained at an error of ±1 Celsius degree. According to a conventional bimetal control, the temperature error is ± around five Celsius degrees and large: therefore, when a low water temperature is maintained within the error, thereby a food is frozen, an ice crystal is enlarged too much in the frozen food, and thereby the texture damage is generated; when a high water temperature is maintained within the error, the freshness degradation and a low temperature fermentation are generated; whereas, according to the invention, the problems has been solved.

Furthermore, according to the conventional low-temperature-refrigeration freshness-maintaining and storing method, it is impossible to remove adhesion matters such as dirt and dust adhered to a food; whereas, the invention has a washing effect of removing the adhesion matters by underwater ultrasound. According to the washing effect, it is enhanced to maintain the freshness of a food.

Then it is known that ethanol has a germicidal action; according to the invention, because the temperature of the ethanol blended water 10 is maintained at zero Celsius degree and an error range thereof is suppressed at ±1 Celsius degree, miscellaneous fungi are not propagated.

Moreover, it is also proved that the life of the ultrasonic vibrators 3 is longer when the ethanol blended water 10 is used than when pure water is used.

Then by installing an ultraviolet germicidal device 12 in a cooling circulation line in the water tank 2, it is possible in the ethanol blended water 10 to prevent fungi from being propagated and to sterilize the fungi by an ultraviolet.

The cooling circulation line is a passage where the ethanol blended water 10 is drawn in from the water tank 2 by the agitator pump 6, is cooled by the treated water cooler 4, and is discharged to the water tank 2 again.

The underwater-cooling water-temperature maintaining apparatus 1 of the invention may also comprise a generator capacitor 4b configured to generate power by using a driving force of a treated water cooler drive motor 4a, which is a motivity source of the treated water cooler 4, and by working with the motor 4a, and to further accumulate the power.

By comprising the generator capacitor 4b, it is possible to cover power of each appliance, lighting, and the like and to contribute to the energy saving.

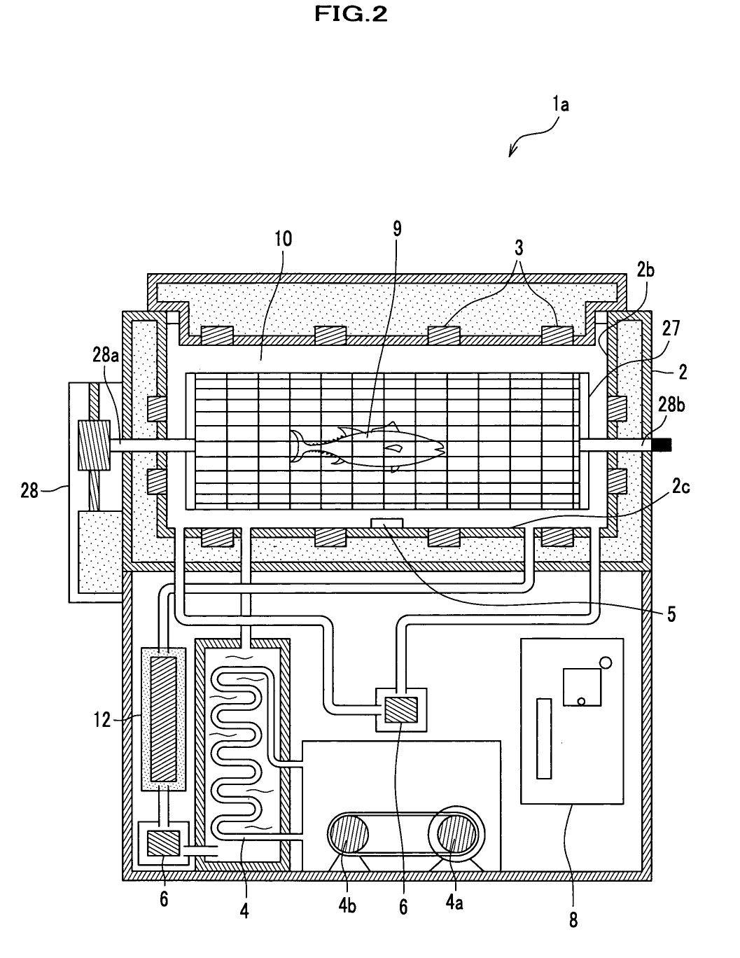

In FIGS. 2 to 5 are shown other configuration examples of FIG. 1.

As shown in FIG. 2, an underwater-cooling water-temperature maintaining apparatus 1a may also comprise an underwater rotation mesh basket 27 instead of the underwater wave diffusion nets 7. The underwater rotation mesh basket 27 has any one of a cylindrical shape and a box shape, has a space inside which the food 9 is put, and a circumference of the basket 27 is surrounded by a net and the like. On a pair of wall faces of the underwater rotation mesh basket 27, the basket 27 comprises rotation shafts 28a, 28b configured to be supported by the walls 2b of the water tank 2 on a same straight line, and is freely rotatable by the shafts 28a, 28b without contacting the walls 2b and bottom 2c of the water tank 2 and the water tank lid 2a.

Thus in accordance with the underwater-cooling water-temperature maintaining apparatus 1a, the food 9 is put in the underwater rotation mesh basket 27 and the cooling treatment of the food 9 is performed by rotating the basket 27 under water.

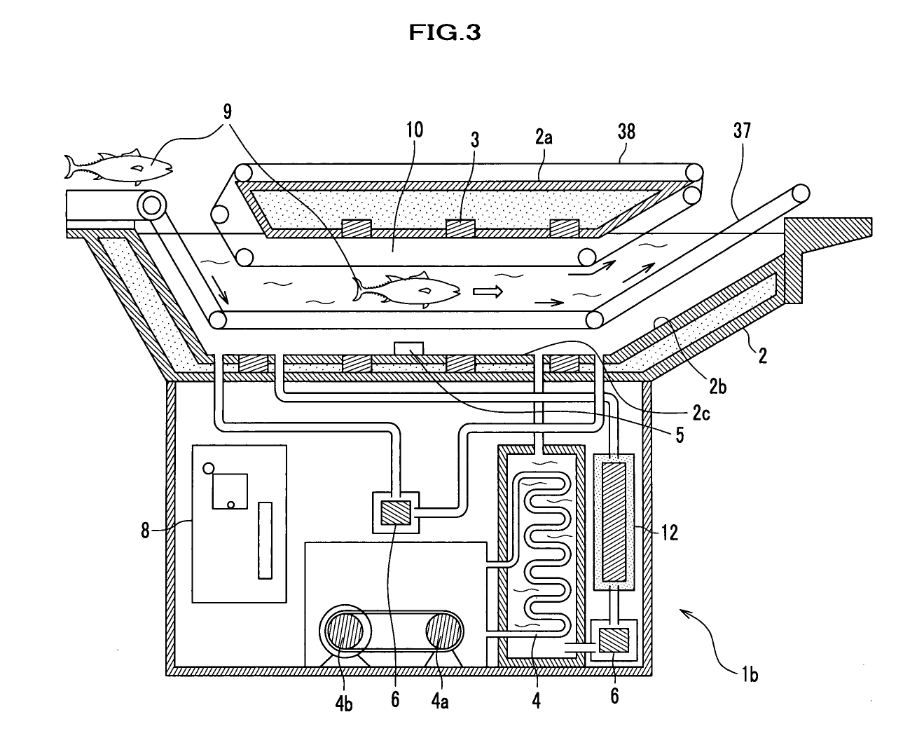

Furthermore, an underwater-cooling water-temperature maintaining apparatus 1b shown in FIG. 3 may also comprises a lower conveyor 37 on the bottom 2c of the water tank 2 instead of the underwater wave diffusion nets 7. In this case, in accordance with the underwater-cooling water-temperature maintaining apparatus 1b, the food 9 is put on the lower conveyor 37, and the cooling treatment of the food 9 is performed by moving it under water over a definite time in the water tank 2.

When the underwater rotation mesh basket 27 is provided in the water tank 2 in cooling the food 9 of which a buoyant force is large, a partition is made inside the basket 27; when the lower conveyor 37 is installed in the water tank 2, an upper conveyor 38 is further installed on an underwater level of the water tank lid 2a, the conveyor 38 is rotated reversely to the conveyor 37, and thereby the foods 9 floating may move under water in the water tank 2 by the conveyor 38.

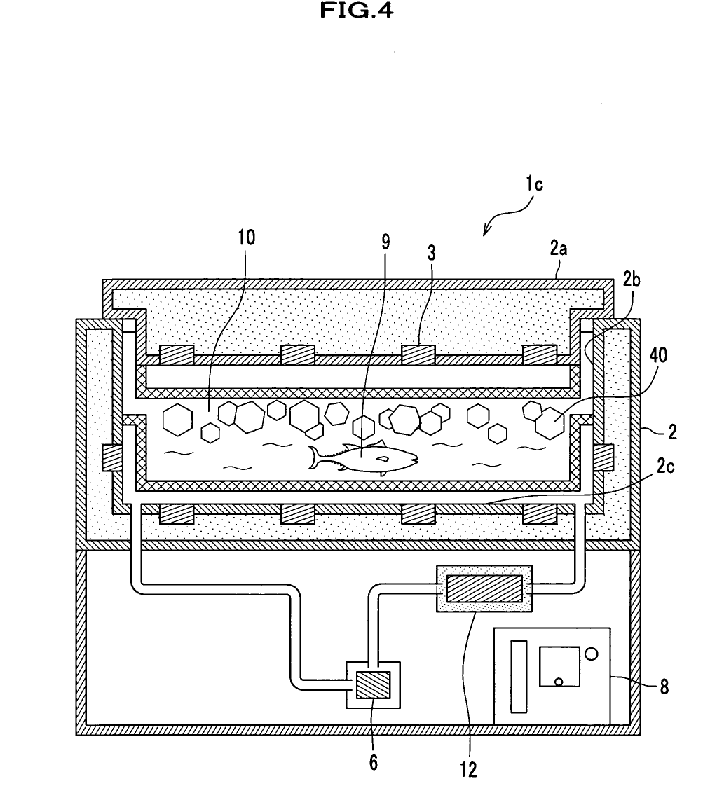

FIG. 4 shows a configuration of an underwater-cooling water-temperature maintaining apparatus 1c where the treated water cooler 4 is not installed. When the treated water cooler 4 is not installed or its cooling function does not normally operate due to its malfunction, ice blocks 40 are put in the water tank 2 in some case in order to cool the ethanol blended water 10 therein.

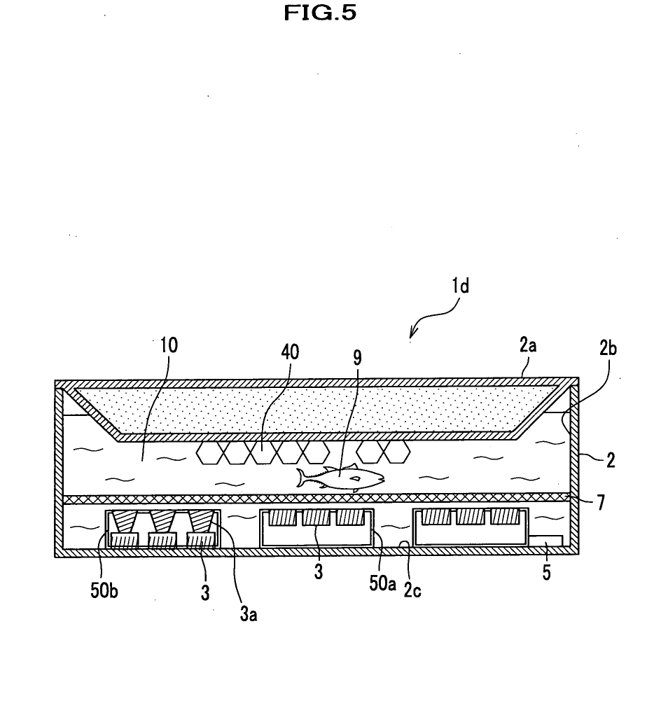

FIG. 5 shows a configuration of an underwater-cooling water-temperature maintaining apparatus id where the ultrasonic vibrators 3 cannot be attached to the water tank 2 because an existing water tank is used as the water tank 2. In this case the ultrasonic vibrators 3 are installed by being put in the ultrasonic vibrator storage boxes 50a, 50b and being thrown in the water tank 2. Then by installing one underwater wave diffusion net 7 above the ultrasonic vibrator storage boxes 50a, 50b and further by putting the food 9 on the net 7, it is possible to obtain an effect similar to the underwater-cooling water-temperature maintaining apparatus 1 firstly shown.

The ultrasonic vibrator storage box 50b where the ultrasonic vibrators 3 with the fallopian-tube wave diffusion guides 3a are put is installed to further diffuse waves.

Furthermore, not only when the existing water tank is used as the water tank 2, but also when each of the lid 2a, walls 2b, and bottom 2c of the water tank 2 is made a vacuum heat-insulation double-layer structure, and when a propagation direction of waves of the ultrasonic vibrators 3 is changed, the vibrators 3 may be put in any of the ultrasonic vibrator storage boxes 50a, 50b and be also installed by being fixed to the lid 2a, walls 2b, and bottom 2c of the water tank 2, or by being thrown in the tank 2.

Thus the underwater-cooling water-temperature maintaining apparatuses 1, 1a, 1b, 1c, 1d of the present invention may not only cool the food 9, but also thaw the food 9, which is frozen, under water by increasing the temperature of the ethanol blended water 10. Furthermore, because a freezing point of the ethanol blended water 10 is reduced by increasing an addition amount of ethanol, it is also possible to freeze the food 9 under water. Moreover, it is also possible to wash the outside of the food 9 under water and maintain its freshness, and to perform a sterilization treatment to fungi under water, which are adhered to the outside of the food 9. Other than these, it is possible to oscillate ultrasound of the ultrasonic vibrators 3 in a frequency band most suitable for a condition, under which the apparatuses 1, 1a, 1b, 1c, 1d are used, by changing a frequency of the ultrasound so that the waves of the ultrasound reach the core portion of the food 9; or by changing the temperature of the ethanol blended water 10 to that suitable for obtaining an effect of washing the outside of the food 9 by the waves.

Each of the underwater-cooling water-temperature maintaining apparatuses 1, 1a, 1b, 1c, 1d of the present invention has features of the following eight functions of:
[1] maintaining the freshness of the food 9 by cooling it to zero Celsius degree under water;
[2] maintaining the freshness of the food 9 by storing it at zero Celsius degree under water;
[3] maintaining the freshness of the food 9 by sterilizing it;
[4] washing adhesion matters to the outside of the food 9 by ultrasound;
[5] maintaining the freshness of the food 9 frozen and thawing it rapidly at a cool temperature;
[6] thawing the food 9 frozen, and then maintaining its freshness at a cool-temperature and storing it under water;
[7] thawing the food 9 frozen rapidly at a cool temperature and checking the reproduction of its freshness in order to check its freshness quality, and sterilizing fungi adhered to its outside; and
[8] being enabled to perform rapid freezing of the food 9 by adjusting an addition amount of ethanol when the treated water cooler 4 has a high cooling capacity.

Moreover, when each of the lid 2a, walls 2b, and bottom 2c of the water tank 2 of the underwater-cooling water-temperature maintaining apparatuses 1, 1a, 1b, 1c is made a vacuum heat-insulation double-layer structure, it becomes possible to perform rapid cooling of the food 9 by filling liquid nitrogen in the vacuum portion.

What is claimed is:

1. An underwater-cooling water-temperature maintaining apparatus of a food comprising:
a water tank where a cooled stuff and cooling treated water of which a freezing point is not more than zero Celsius degree;
a treated water cooler configured to cool the cooling treated water;
a water temperature detection sensor configured to detect a water temperature of the cooling treated water;
an agitator pump configured to equalize the water temperature of the cooling treated water in the water tank;
ultrasonic vibrators configured to oscillate ultrasound toward an inside of the water tank in order to prevent the cooled stuff from being frozen; and
a controller configured to control the ultrasonic vibrators, the water temperature detection sensor, the treated water cooler, and the agitator pump so as to maintain the water temperature of the cooling treated water at a temperature at which the cooled stuff is not frozen.

2. The underwater-cooling water-temperature maintaining apparatus according to claim 1, wherein the treated water cooler cools the cooling treated water to not more than zero Celsius degree.

3. The underwater-cooling water-temperature maintaining apparatus according to claim 1, wherein the water temperature detection sensor is a thermistor control temperature sensor configured to measure the water temperature at an error within ±1 Celsius degree.

4. The underwater-cooling water-temperature maintaining apparatus according to claim 1, wherein the water tank comprises an underwater wave diffusion net configured to diffuse waves generated by ultrasound oscillated by the ultrasonic vibrators.

5. The underwater-cooling water-temperature maintaining apparatus according to claim 4, wherein the underwater wave diffusion net is installed away from the ultrasonic vibrators by about 20 mm.

6. The underwater-cooling water-temperature maintaining apparatus according to claim 1, wherein the water tank comprises an underwater rotation mesh basket configured to be installed away from inside faces of the water tank, and wherein the underwater rotation mesh basket is formed so as to have a space, inside which the cooled stuff is put, and is rotated in the water tank.

7. The underwater-cooling water-temperature maintaining apparatus according to claim 1, wherein the water tank comprises an upper conveyor and a lower conveyor in the water tank, and wherein the lower conveyor is rotated reversely to the upper conveyor and moves the cooled stuff to a definite direction.

8. The underwater-cooling water-temperature maintaining apparatus according to claim 1, wherein the water tank has a structure having an insulation material on an outside of the water tank, or a lid, wall, and bottom of the water tank have a double-layer structure and a space between the double layers is kept vacuum.

9. The underwater-cooling water-temperature maintaining apparatus according to claim 1, wherein the ultrasonic vibrators are attached to any one of the lid, wall, bottom of the water tank.

10. The underwater-cooling water-temperature maintaining apparatus according to claim 1, wherein the ultrasonic vibrators are attached to an inside of a box and installed in the water tank.

11. The underwater-cooling water-temperature maintaining apparatus according to claim 1, wherein the treated water cooler comprises a drive motor of a motivity source of the treated water cooler and a generator capacitor configured to generate and accumulate power in conjunction with the drive motor.

12. The underwater-cooling water-temperature maintaining apparatus according to claim 1 further comprising an ultraviolet germicidal device.
